(19) United States
(12) Patent Application Publication
(10) Pub. No.: US 2024/0095724 A1
(43) Pub. Date: Mar. 21, 2024

(54) TECHNIQUES TO PROVIDE SECURE CRYPTOGRAPHIC AUTHENTICATION OF CONTACTLESS CARDS BY DISTRIBUTED ENTITIES

(71) Applicant: Capital One Services, LLC, McLean, VA (US)

(72) Inventors: Kevin OSBORN, Newton Highlands, MA (US); Jonathan T. BLOCKSOM, Reston, VA (US); Michael WOLF, Ellicott City, MD (US)

(21) Appl. No.: 18/244,838

(22) Filed: Sep. 11, 2023

Related U.S. Application Data
(60) Provisional application No. 63/405,749, filed on Sep. 12, 2022.

(51) Int. Cl. G06Q 20/38; G06Q 20/34; H04L 9/00; H04L 9/32

(52) U.S. Cl. CPC G06Q 20/382; G06Q 20/352; H04L 9/3247; H04L 9/50

(57) ABSTRACT

Example embodiments herein disclose systems and methods for the secure cryptographic authentication of contactless cards by distributed entities. In an example embodiment, a distributed network authentication system can comprises a client node and a distributed ledger node in data communication with the client node, wherein the distributed ledger can contain a database storing a mapping. The client node can receive, from a client device, an authentication request, and responsive to the authentication request, transmit, to the distributed ledger node, a query. The distributed ledger node can receive, from the client node, the query, submit the query to the database, receive, from the database responsive to the query, an identification of at least one selected from the group of a validation node and a validation node address, and transmit, to the client node, the identification.

### BACKGROUND

Contactless card products have become so universally well-known and ubiquitous that they have fundamentally changed the manner in which financial transactions and dealings are viewed and conducted in society today. Contactless card products are most commonly represented by plastic card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transaction and to the customers. This need continues to grow as electronic transactions performed with contactless cards constitute an increasingly large share of commercial activity. Accordingly, there is a need to provide businesses and users with an appropriate solution that overcome current deficiencies to provide data security, authentication, and verification for contactless cards.

### BRIEF SUMMARY

In some aspects, the techniques described herein relate to a distributed network authentication system, including: a client node; and a distributed ledger node in data communication with the client node, wherein the distributed ledger contains a database storing a mapping; and wherein the client node is configured to: receive, from a client device, an authentication request, and responsive to the authentication request, transmit, to the distributed ledger node, a query, and wherein the distributed ledger node is configured to: receive, from the client node, the query, submit the query to the database, receive, from the database responsive to the query, an identification of at least one selected from the group of a validation node and a validation node address, and transmit, to the client node, the identification.

In some aspects, the techniques described herein relate to a method performed by a distributed network authentication system including a client node and a distributed ledger node, the method including: receiving, by the client node from a client device, an authentication request; responsive to the authentication request, transmitting, by the client node to the distributed ledger node, a query, receiving, by the distributed ledger node from the client node, the query, submitting, by the distributed ledger node, the query to the database, receiving, by the distributed ledger node from the database responsive to the query, an identification of at least one selected from the group of a validation node and a validation node address, and transmitting, by the distributed ledger node to the client node, the identification.

In some aspects, the techniques described herein relate to a non-transitory computer-readable medium including instructions for execution by a distributed network authentication system including a distributed ledger node containing a database, wherein, when executed, the instructions cause the distributed network authentication system to perform procedures including: receiving, from a client node, a query, submitting the query to the database, receive, from the database responsive to the query, an identification of at least one selected from the group of a validation node and a validation node address, and transmit, to the client node, the identification.

In some aspects, the techniques described herein relate to a non-transitory computer-readable medium, wherein: the distributed network authentication system further includes the client node, and the procedures further include: receiving, by the client node from a client device, an authentication request, and responsive to the authentication request, transmitting, by the client node to the distributed ledger node, the query.

### BRIEF DESCRIPTION OF THE SEVERAL VIEWS OF THE DRAWINGS

In the this specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

FIG. 1 illustrates a data transmission system in accordance with one embodiment.

FIG. 2 illustrates a data transmission system in accordance with one embodiment.

FIG. 3 illustrates a contactless card in accordance with one embodiment.

FIG. 4 illustrates a contactless card component in accordance with one embodiment.

FIG. 5 illustrates a sequence flow in accordance with one embodiment.

FIG. 6 illustrates a data structure in accordance with one embodiment.

FIG. 7 is a diagram of a key system in accordance with one embodiment.

FIG. 8 is a flowchart of a method of generating a cryptogram in accordance with one embodiment.

FIG. 9 is a flowchart of a method illustrating key diversification in accordance with one embodiment.

FIG. 10 is a flowchart of a method for card activation in accordance with one embodiment.

FIG. 11 illustrates a data payload in accordance with one embodiment.

FIG. 12 illustrates a personalization and validation system in accordance with one embodiment.

FIG. 13 illustrates a distributed network authentication system in accordance with one embodiment.

FIG. 14 illustrates a method performed by a distributed network authentication system in accordance with one embodiment.

FIG. 15 illustrates a computer architecture in accordance with one embodiment.

FIG. 16 illustrates a communications architecture in accordance with one embodiment.

### DETAILED DESCRIPTION

Example embodiments herein disclose systems and methods for the secure cryptographic authentication of contactless cards by distributed entities. As contactless cards have become ubiquitous, it is necessary for many entities, distributed across various countries, industries, and locations, to be able to securely communicate, authenticate, and verify contactless cards.

The systems and methods described herein to provide data security, authentication, and verification for contactless cards provide many advantages. For example, the systems and methods described herein allow for card tap requests to be routed to many different card validators through the addition of an issuer identification to a data payload communicated between the card and various other devices (e.g., clients devices and/or servers).

As another example, personalization of the card can be decoupled from validation of the card, which advantageously permits for multiple entities to perform validation securely, consistently, and without the unnecessary exchange of sensitive data. In some examples described herein, the decoupling of card personalization from validation may be achieved by adding a key identifier to a data payload communicated between the card and various other devices (e.g., clients devices and/or servers). In other examples described herein, the decoupling of card personalization from validation may be achieved by deriving a shared secret from a master key. In yet other examples described herein, the decoupling of card personalization from validation may be achieved by avoiding the use of the permanent account number (PAN) sequence number (PSN) for key derivation.

As another example, a challenge may be incorporated to advantageously avoid or reduce the risk of preplay and/or replay attacks. In some examples, a challenge may be generated and linked to a session, and then written to the card. The challenge can be used in generating encrypted a data, such as a cryptogram, and session validation can be added to the validation logic.

As further examples, additional improvements to data security, authentication, and validation can be made. For example, a bespoke NFC specification, a dormant applet, a signed hash of the card product customer identifier, a centralized validator, and generic cryptography may be advantageously used.

As further examples, it is advantageous to distribute the authentication functionality across a distributed network. This can be done without the establishment of a centralized authority, and instead a distributed ledger can be implemented to coordinate routing of authentication and transactions between different entities. In some examples, the different entities can be one or more of financial entities, merchants, service providers, other card-issuing entities, and other entities storing keys for authentication. The different entities can act as, or in addition to, a consortium authority or other administrative entity associated with the network.

Distribution of the authentication functionality across a network can advantageously allow for different entities to participate in the provision of data security, authentication, and verification for contactless cards. In addition, the different entities can be allowed to manage their own resources. Further, the different entities can provide access to clients applications (e.g., ecommerce applications) across a broad range of contactless cards, broader than any single entity could provide. By maintaining the distributed ledger and updating when necessary, a distributed network that meets the current needs of the different entities at any given time. These functionalities can be achieved while maintaining the secure communication, authentication, and verification described herein.

In some examples, one or more client nodes serving application programming interfaces (APIs) can be constructed. In some examples, each client node can be associated with a routing number, however, in other examples, no such association can be made.

Via the APIs, the client nodes can retrieve a validation node address (e.g., a uniform resource indicator (URI), a uniform resource locator (URL), or other link) to a validation node. The validation node addresses can be preconfigured in a primary and secondary fashion to (e.g., via the Domain Name System (DNS) or other implementation) in order to provide backup redundancy. A load balancer service, such as a DNS service, can provide load balancing and data traffic direction.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

In some examples, the client nodes can be in data communication with one or more distributed ledger nodes. The distributed ledger nodes can contain a mapping, such as in the form of a database. The mapping may include, e.g., a mapping between the validation node address and the validation node, a mapping between the routing number and the validation node address, and/or a mapping between the routing number and the validation node. In some examples, the mapping can include a digital signature associated with a specific entity having permission to validate for a particular routing number. Based on one or more of these associations, the client node can call the validation node for validation and/or provide direction to the client device to reach the appropriate validation node. This can be accomplished by calling a validation API associated with the validation node.

In some examples, iterations of the aforementioned mappings can also include a software or applet version number. The version number can be used to identify a validation node or validation node address or choose between multiple validation addresses for one validation node.

In some examples, client nodes and distributed ledger nodes can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the network.

In some examples, distributed ledger nodes with appropriate permissions can update a mapping to reflect a different association between, e.g., a routing number, a validation node address, and a validation node.

In some examples, degrees of permissions can be issued. For example, a client node that functions to route data to one or more validation nodes can be given a certain level of permissions. As another example, a distributed ledger node having the capability to update a mapping may have a different, higher level of permissions.

In some examples, upon receipt of an authentication request, a client device can call (e.g., via an API) the client node. The call can include a routing number and/or an applet or software version number, and the client node can query a mapping contained in a distributed ledger node. Once the query returns the identification of a validation node and/or a validation node address associated with that routing number and/or applet or software version, the client node can reply to the client device. The client device can then proceed with authentication with the validation node. The authentication can be performed by, e.g., the systems and methods described herein, such as by the generation, encryption, transmission, decryption, and validation of a cryptogram as described herein.

In some examples, the client node can be co-resident with the validation node. In these examples, the client node can handle the authentication in a single call from the client device. In some examples, this can be acceptable only if it is permissible for the full authentication transmission (e.g., a cryptogram as described herein) to be sent to client nodes that are not involved in authentication.

In some examples, if the client nodes receives, from a client device, a routing number that is not handled by its location, the client node can return a code indicating that this routing number is not handled, along with validation node address for the responsible validation node. The client device can then send the full authentication transmission to the responsible validation node using the received validation node address.

In some examples, client nodes can enter the distributed network with different permissions. For example, a client node can be a read-only router of data. As another example, a client node can have permission to send messages to a distributed ledger node updating one or more routing paths for one or more routing numbers. However, the client node would be prevented from updating one or more routing paths for one or more routing numbers for other entities that control other routing numbers which are not associated with the client node or that did not grant this permission. As another example, the distributed ledger node can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to one or more client nodes, distributed ledger nodes, and/or validation nodes, if security, legal, and/or financial conditions are met, however, delegation is not required.

All of the foregoing examples provide many advantages with respect to data security, authentication, and verification for contactless cards. It is understood that these and further advantages may be achieved by a combination of one or more of the foregoing examples.

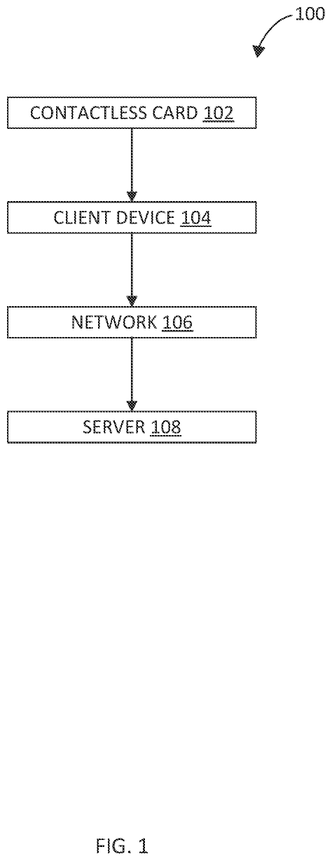

FIG. 1 illustrates a data transmission system 100 according to an example embodiment. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with client device 104.

System 100 may include client device 104, which may be a network-enabled computer. As referred to herein, a network-enabled computer may include, but is not limited to a computer device, or communications device including, e.g., a server, a network appliance, a personal computer, a workstation, a phone, a handheld PC, a smart card (e.g., a contactless card or a contact-based card), a personal digital assistant, a thin client, a fat client, an Internet browser, or other device. Client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 104 of system 100 may execute one or more applications, such as software applications, that enable, for example, network communications with one or more components of system 100, transmit and/or receive data, and perform the functions and processes described herein.

The client device 104 may be in communication with one or more server(s) 108 via one or more network(s) 106, and may operate as a respective front-end to back-end pair with server 108. The client device 104 may transmit, for example from a mobile device application executing on client device 104, one or more requests to server 108. The one or more requests may be associated with retrieving data from server 108. The server 108 may receive the one or more requests from client device 104. Based on the one or more requests from client device 104, server 108 may be configured to retrieve the requested data from one or more databases (not shown). Based on receipt of the requested data from the one or more databases, server 108 may be configured to transmit the received data to client device 104, the received data being responsive to one or more requests.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers 108. In some examples, server 108 may include one or more processors, which are coupled to memory. In some examples, the server may be a network-enabled computer. The server 108 may be configured as a central system, server or platform to control and call various data at different times to execute a plurality of workflow actions. Server 108 may be configured to connect to the one or more databases. The server 108 may be connected to at least one client device 104. Server 108 may execute one or more applications, such as software applications, that enable, for example, network communications with one or more components of system 100, transmit and/or receive data, and perform the functions and processes described herein. Server 108 may be in data communication with one or more components of system 100 via one or more networks and/or one or more intermediary devices (e.g., one or more network-enabled computers).

In some examples, server 108 can be a dedicated server computer, a bladed server, or can be a personal computer, a laptop computer, a notebook computer, a palm top computer, a network computer, mobile devices, a wearable device, or any processor-controlled device capable of supporting the system 100. In some examples, the server 108 can be one or more client devices 104. While FIG. 1 illustrates a single server 108, it is understood that other embodiments can use multiple servers or multiple computer systems as necessary or desired to support the users and can also use back-up or redundant servers to prevent network downtime in the event of a failure of a particular server. In some examples, server 108 can be a dedicated server computer, such as bladed servers, or can be personal computers, laptop computers, notebook computers, palm top computers, network computers, mobile devices, wearable devices, or any processor-controlled device capable of supporting the system 100.

In some examples, exemplary procedures in accordance with the present disclosure described herein can be performed by a processing arrangement and/or a computing arrangement (e.g., a computer hardware arrangement). Such arrangement can be, for example entirely or a part of, or include, but not limited to, a computer and/or processor that can include, for example one or more microprocessors, and use instructions stored on a computer-accessible medium (e.g., RAM, ROM, hard drive, or other storage device). For example, a computer-accessible medium can be part of the memory of the contactless card 102, client device 104, server 108, and/or or other computer hardware arrangement.

In some examples, a computer-accessible medium (e.g., a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

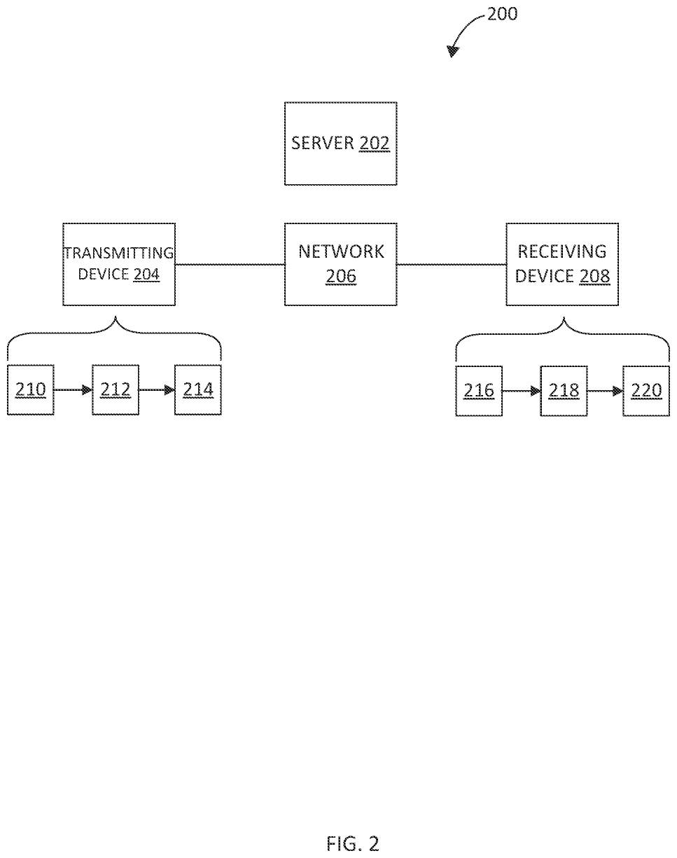

FIG. 2 illustrates a data transmission system according to an example embodiment. System 200 may include a transmitting or transmitting device 204, a receiving or receiving device 208 in communication, for example via network 206, with one or more servers 202. Transmitting or transmitting device 204 may be the same as, or similar to, contactless card 102 or client device 104 discussed above with reference to FIG. 1A. Receiving or receiving device 208 may be the same as, or similar to, client device 104 discussed above with reference to FIG. 1A. Network 206 may be similar to network 115 discussed above with reference to FIG. 1A. Server 202 may be similar to server 108 discussed above with reference to FIG. 1A. Although FIG. 2 shows single instances of components of system 200, system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 2, system 200 may be configured to implement key diversification. For example, a sender and recipient may desire to exchange data (e.g., original sensitive data) via respective devices 204 and 208. As explained above, although single instances of transmitting device 204 and receiving device 208 may be included, it is understood that one or more transmitting devices 204 and one or more receiving devices 208 may be involved so long as each party shares the same shared secret symmetric key. In some examples, the transmitting device 204 and receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and receiving device 208 may be provided with the same master symmetric key, and further that part of the data exchanged between the transmitting device 204 and receiving device 208 comprises at least a portion of data which may be referred to as the counter value. The counter value may comprise a number that changes each time data is exchanged between the transmitting device 204 and the receiving device 208.

System 200 may include one or more networks 206. In some examples, network 206 may be one or more of a wireless network, a wired network or any combination of wireless network and wired network, and may be configured to connect one or more transmitting devices 204 and one or more receiving devices 208 to server 202. For example, network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 206 may include, without limitation, telephone lines, fiber optics, IEEE Ethernet 902.3, a wide area network, a wireless personal area network, a LAN, or a global network such as the Internet. In addition, network 206 may support an Internet network, a wireless communication network, a cellular network, or the like, or any combination thereof. Network 206 may further include one network, or any number of the exemplary types of networks mentioned above, operating as a stand-alone network or in cooperation with each other. Network 206 may utilize one or more protocols of one or more network elements to which they are communicatively coupled. Network 206 may translate to or from other protocols to one or more protocols of network devices. Although network 206 is depicted as a single network, it should be appreciated that according to one or more examples, network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through network 206. For example, communication between the one or more transmitting devices 204 and the one or more receiving devices 208 may occur via at least one of NFC, Bluetooth, RFID, Wi-Fi, and/or the like.

At block 150, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 152, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 152 without encryption.

At block 154, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 156, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 158, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via respective transmitting device 204 and receiving device 208, a different counter value may be selected producing a different diversified symmetric key. By processing the counter value with the master symmetric key and same symmetric cryptographic algorithm, both the transmitting device 204 and receiving device 208 may independently produce the same diversified symmetric key. This diversified symmetric key, not the master symmetric key, is used to protect the sensitive data.

As explained above, both the transmitting device 204 and receiving device 208 each initially possess the shared master symmetric key. The shared master symmetric key is not used to encrypt the original sensitive data. Because the diversified symmetric key is independently created by both the transmitting device 204 and receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

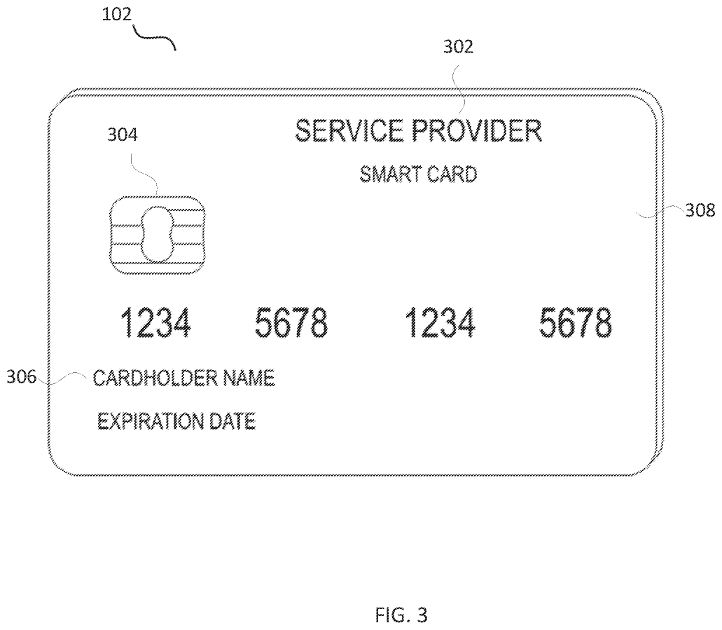

FIG. 3 illustrates an example configuration of a contactless card 102, which may include a contactless card, a payment card, such as a credit card, debit card, or gift card, issued by a service provider as displayed as service provider indicia 302 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

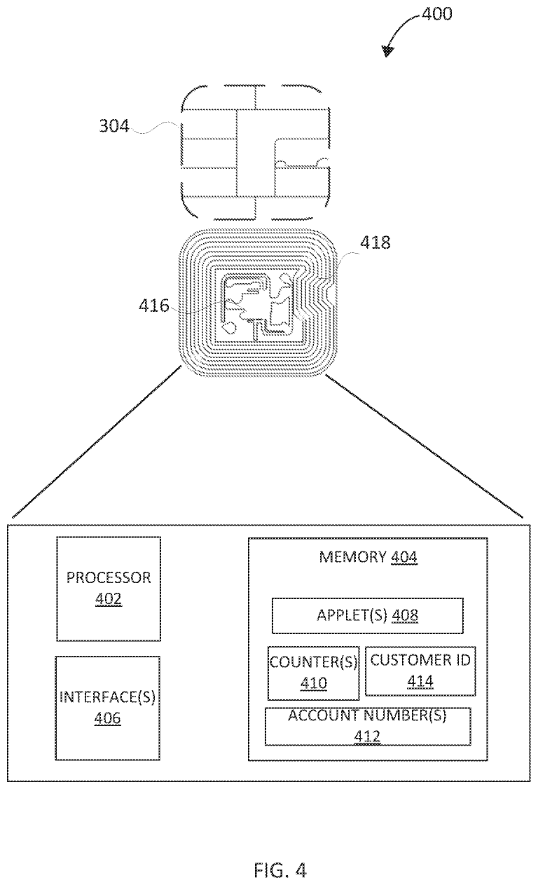

The contactless card 102 may also include identification information 306 displayed on the front and/or back of the card, and a contact pad 304. The contact pad 304 may include one or more pads and be configured to establish contact with another client device, such as an automated teller machine (ATM), a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 4. These components may be located behind the contact pad 304 or elsewhere on the substrate 308, e.g. within a different layer of the substrate 308, and may electrically and physically coupled with the contact pad 304. The contactless card 102 may also include a magnetic strip or tape, which may be located on the back of the card (not shown in FIG. 3). The contactless card 102 may also include a Near-Field Communication (NFC) device coupled with an antenna capable of communicating via the NFC protocol. Embodiments are not limited in this manner.

As illustrated in FIG. 2, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions described herein.

The memory 404 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypted data.

The memory 404 may be configured to store one or more applet(s) 408, one or more counter(s) 410, a customer identifier 414, and the account number(s) 412, which may be virtual account numbers. The one or more applet(s) 408 may comprise one or more software applications configured to execute on one or more contactless cards, such as a Java® Card applet, enable data communications, and perform the functions and processes described herein. However, it is understood that applet(s) 408 are not limited to Java Card applets, and instead may be any software application operable on contactless cards or other devices having limited memory. The one or more counter(s) 410 may comprise a numeric counter sufficient to store an integer. The customer identifier 414 may comprise a unique alphanumeric identifier assigned to a user of the contactless card 102, and the identifier may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device for autofilling by an autofilling service.

The processor 402 and memory elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the contactless card 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. The terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 101 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 101 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when the mobile device 10 is woken up, NFC may be enabled and the device 110 may be configured to read available tags, but no action is taken responsive to the reads.

To keep the counter(s) 410 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique described herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

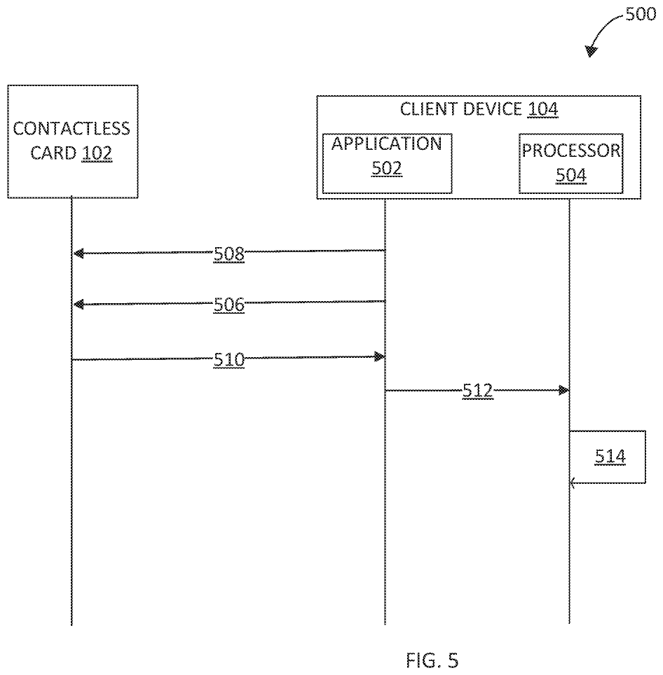

FIG. 5 is a timing diagram illustrating an example sequence for providing authenticated access according to one or more embodiments of the present disclosure. Sequence flow 500 may include contactless card 102 and client device 104, which may include an application 502 and processor 504.

At line 508, the application 502 communicates with the contactless card 102 (e.g., after being brought near the contactless card 102). Communication between the application 502 and the contactless card 102 may involve the contactless card 102 being sufficiently close to a card reader (not shown) of the client device 104 to enable NFC data transfer between the application 502 and the contactless card 102.

At line 506, after communication has been established between client device 104 and contactless card 102, contactless card 102 generates a message authentication code (MAC) cryptogram. In some examples, this may occur when the contactless card 102 is read by the application 502. In particular, this may occur upon a read, such as an NFC read, of a near field data exchange (NDEF) tag, which may be created in accordance with the NFC Data Exchange Format. For example, a reader application, such as application 502, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 502 may be configured to transmit a request to contactless card 102, the request comprising an instruction to generate a MAC cryptogram.

At line 510, the contactless card 102 sends the MAC cryptogram to the application 502. In some examples, the transmission of the MAC cryptogram occurs via NFC, however, the present disclosure is not limited thereto. In other examples, this communication may occur via Bluetooth, Wi-Fi, or other means of wireless data communication. At line 512, the application 502 communicates the MAC cryptogram to the processor 504.

At line 514, the processor 504 verifies the MAC cryptogram pursuant to an instruction from the application 122. For example, the MAC cryptogram may be verified, as explained below. In some examples, verifying the MAC cryptogram may be performed by a device other than client device 104, such as a server of a banking system in data communication with the client device 104. For example, processor 504 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

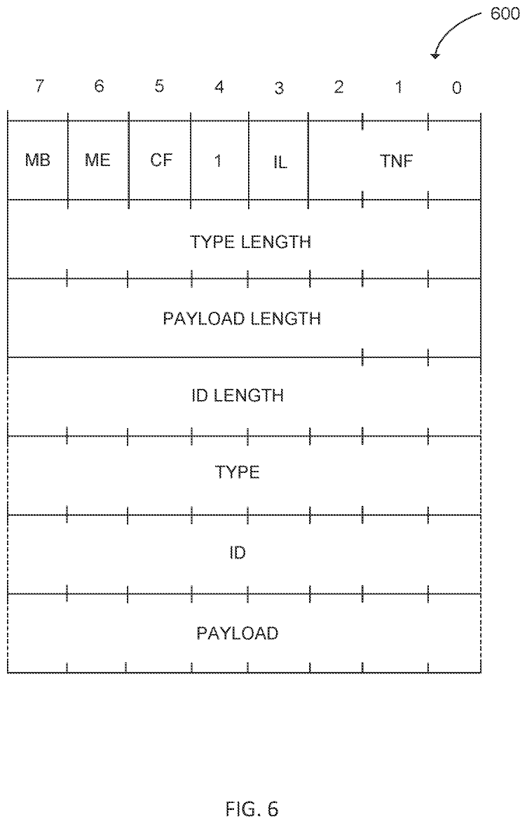

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

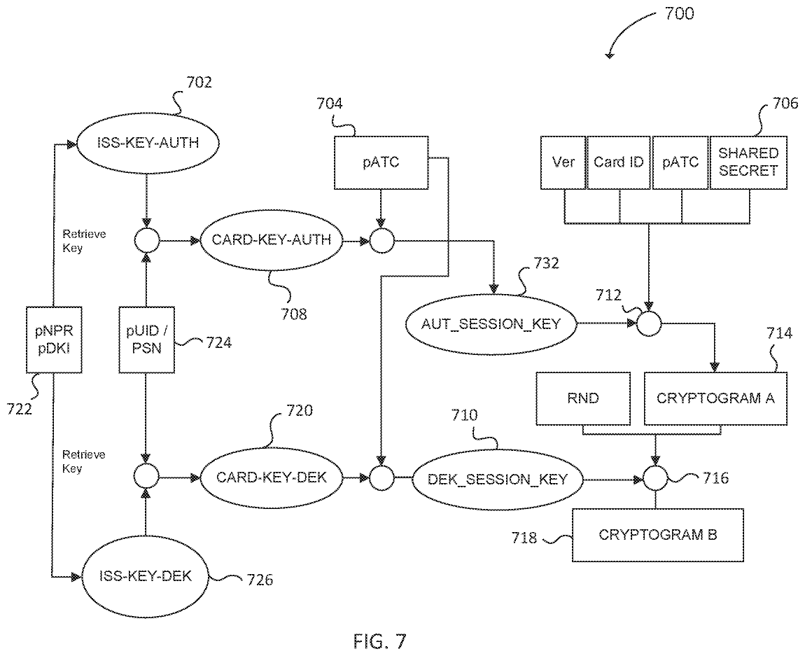

FIG. 7 illustrates a diagram of a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, two issuer master keys 702, 726 are diversified into card master keys 708, 720, which are unique for each card. In some examples, a network profile record ID (pNPR) and/or derivation key index (pDKI) 722 and unique ID number (pUID) and/or PAN sequence number (PSN) 724, as back office data, may be used to identify which Issuer Master Keys 702, 726 to use in the cryptographic processes for authentication. The system performing the authentication may be configured to retrieve values of pNPR, pDKI 722 and pUID, PSN 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’ ∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 704 counter. At each tap of the contactless card, pATC 704 is configured to be updated, and the card master keys Card-Key-AUTH 508 and Card-Key-DEK 720 are further diversified into the session keys Aut-Session-Key 732 and DEK-Session-KEY 710. pATC 704 may be initialized to zero at personalization or applet initialization time. In some examples, the pATC counter 704 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to MAC data 706, and the resulting data or cryptogram A 714 and random number RND may be encrypted using DEK-Session-Key 710 to create cryptogram B or output 718 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 710 derived from the Card-Key-DEK 720. In this case, the ATC value for the session key derivation is the least significant byte of the counter pATC 704.

The format below represents a binary version example embodiment. Further, in some examples, the first byte may be set to ASCII ‘A’.

| Message | | | | |
|---|---|---|---|---|
| Format | | | | |
| 1 | 2 | 4 | 8 | 8 |
| 0x43 | Version | pATC | RND | Cryptogram |
| (Message | | | | A (MAC) |
| Type ‘A’) | | | | |
| Cryptogram | | | | |
| A (MAC) | 8 bytes | | | |
| MAC of | | | | |
| 2 | 8 | 4 | 4 | 18 bytes input data |
| Version | pUID | pATC | Shared Secret | |
| Message | | | | |
| Format | | | | |
| 1 | 2 | 4 | | 16 |
| 0x43 | | | | |
| (Message | Version | pATC | | Cryptogram B |
| Type ‘A’) | | | | |
| Cryptogram | 8 bytes | | | |
| A (MAC) | | | | |
| MAC of | | | | |
| 2 | 8 | 4 | 4 | 18 bytes input |
| | | | | data |
| Version | pUID | pATC | Shared Secret | |
| Cryptogram | 16 | | | |
| B | | | | |
| Sym | | | | |
| Encryption | | | | |
| of | | | | |
| 8 | 8 | | | |
| RND | Cryptogram A | | | |

Another exemplary format is shown below. In this example, the tag may be encoded in hexadecimal format.

| Message | | | | |
|---|---|---|---|---|
| Format | | | | |
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared Secret | |
| Message | | | | |
| Format | | | | |
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram | 16 | | | |
| B | | | | |
| Sym | | | | |
| Encryption | | | | |
| of | | | | |
| 8 | 8 | | | |
| RND | Cryptogram | | | |
| | A | | | |

The UID field of the received message may be extracted to derive, from master keys Iss-Key-AUTH 502 and Iss-Key-DEK 726, the card master keys (Card-Key-Auth 708 and Card-Key-DEK 720) for that particular card. Using the card master keys (Card-Key-Auth 508 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′ 00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC cryptogram 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 510 to produce encrypted data, cryptogram B 718. The data 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

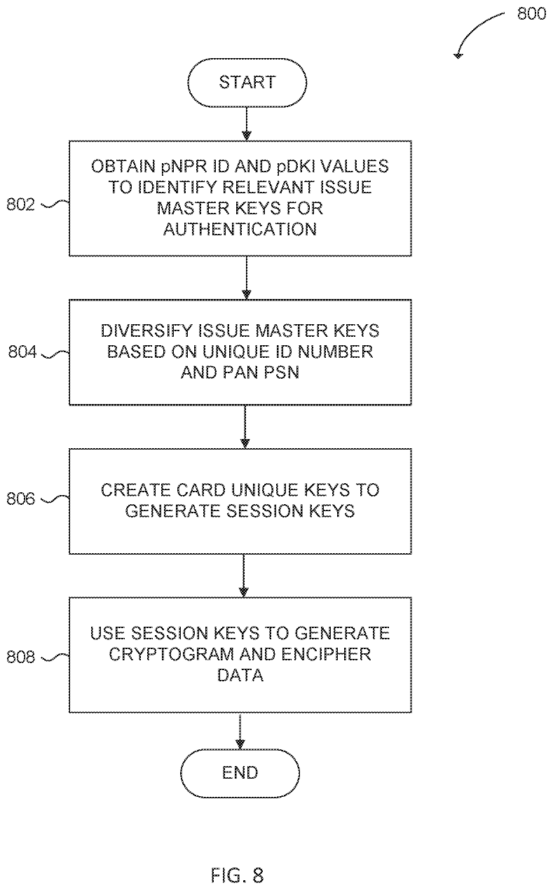

FIG. 8 illustrates a method 800 for generating a cryptogram. For example, at block 802, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 804, Issuer Master Keys may be diversified by combining them with the card's unique ID number (pUID) and the PAN sequence number (PSN) of one or more applets, for example, a payment applet.

At block 806, Card-Key-Auth and Card-Key-DEK (unique card keys) may be created by diversifying the Issuer Master Keys to generate session keys which may be used to generate a MAC cryptogram.

At block 808, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

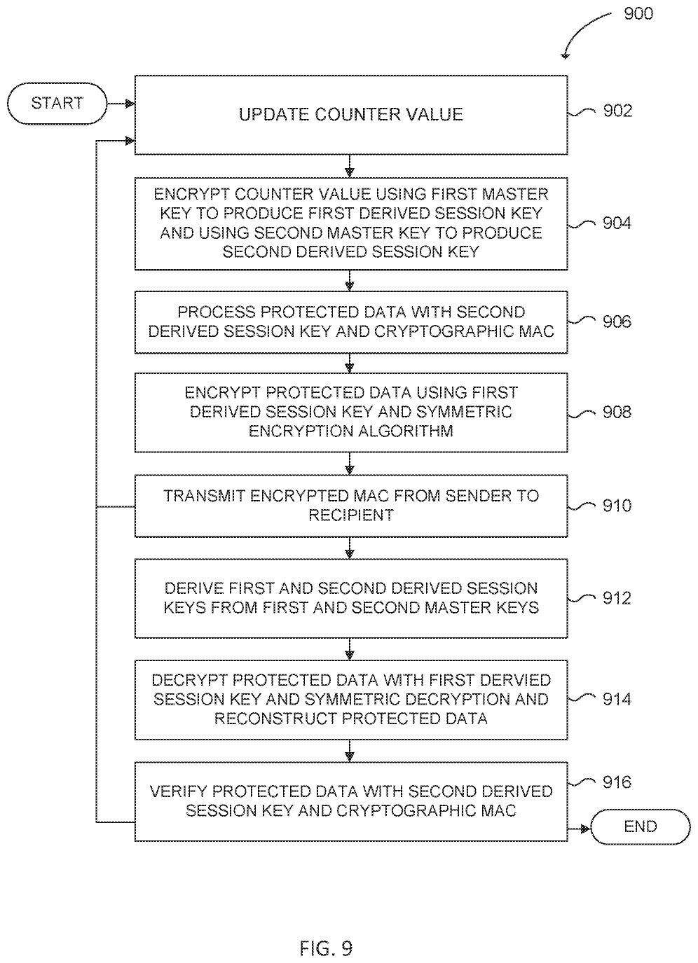

FIG. 9 depicts an exemplary process 900 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 902, and other data, such as data to be protected, which it may secure share with the recipient.

At block 904, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

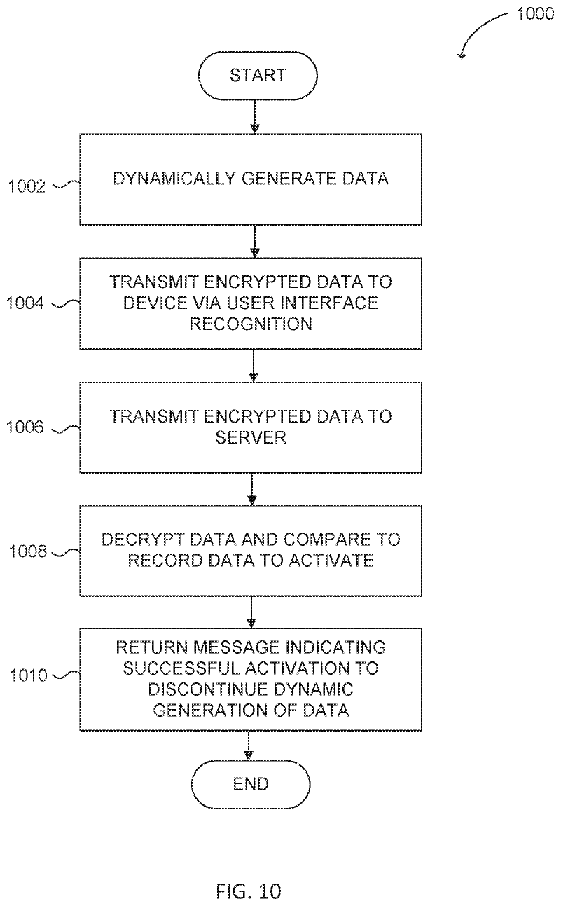

FIG. 10 illustrates a method 800 for card activation according to an example embodiment. For example, card activation may be completed by a system including a card, a device, and one or more servers. The contactless card, device, and one or more servers may reference same or similar components that were previously explained a, such as contactless card 102, client device 104, and a server.

In block, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1006, the one or more portions of the data may be communicated to one or more servers, such as a card issuer server. For example, one or more encrypted portions of the data may be transmitted from the device to the card issuer server for activation of the card.

In block 1008, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

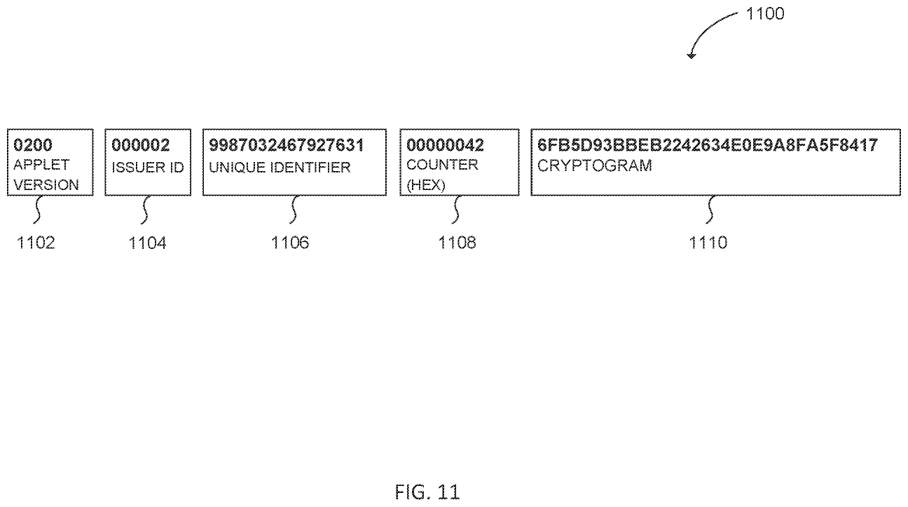

FIG. 11 illustrates an example of a data payload 1100 transmitted by a transmitting device, e.g., a network-enabled computer, to a receiving device, e.g., a network-enabled computer. In some examples, the data payload may be transmitted by a tap of the transmitting device to the receiving device, or an intermediary device that transmits the payload to the receiving device. In some examples, the transmitting device may be a contactless card and the receiving device may be a server in data communication with the contactless card directly, via a network, via one or more intermediary devices (e.g., a network-enabled computer and/or an ATM).

The data payload 1100 may include one or more data fields. As shown in FIG. 11, the data payload 1100 may include a applet version field 1102, an issuer identification field 1104, a unique identifier field 1106, a counter field 1108, and a cryptogram field 1110. In some examples, these fields may be plain text. The applet version field 1102 may include data relating to a version of an applet or other software execute on the transmitting device. In some examples, different applet or software versions may require different personalization and/or validator logic. The issued identifier field 1104 may include data identifying an issuer or other entity associated with the transmitting device. The unique identifier field 1106 may include data relating to an identifier associated with the transmitting device, a customer or user, and/or an account associated with the customer or user. The counter field 1108 may include data relating to a counter and may be in, e.g., a hexadecimal format. The cryptogram field 1110 may include data relating to a cryptogram.

The data payload 1100 provides several benefits. Initially, the data payload 1100 provides the data communication, data security, card authentication, and validation benefits described herein. As another example, the inclusion of the issuer identification field 1104 permits the data payload 1100 to be routed to the appropriate issuing entity for validation (or to the appropriate validator entity if different than the issuing entity). This allows for the decoupling of the issuing entity or the entity that performed personalization of the transmitting device (e.g., when the transmitting device is a contactless card, the contactless card issuing entity) from the validator entity. Accordingly, any validator entity authorized to perform validator, not just the issuing entity or the entity that performed personalization of the transmitting device can be identified in the issuer identification field 1104.

As another example, the inclusion of the unique identifier field 1106 allows for namespacing specific to an individual entity. That is, the unique identifier field 1106 can namespacing for an issuing entity or a validator entity to further the decoupling between personalization and validation.

As noted above, the data payload 1100 permits for the routing to particular entities, such as an issuing entity or a validator entity. A key benefit of the data payload 1100 is that this routing is scalable across many messages, many issuing entities, and many validator entities.

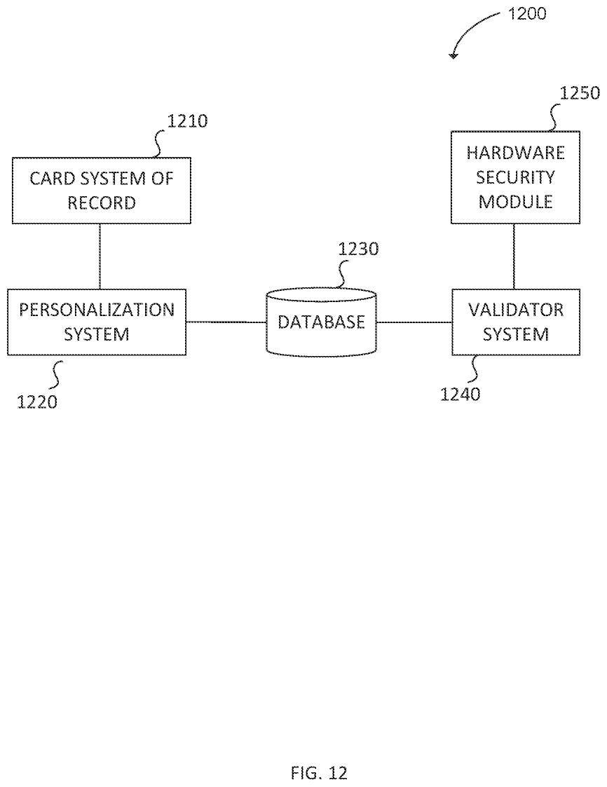

FIG. 12 illustrates an example of a system 1200 configured in accordance with exemplary embodiments discussed herein. The illustrated system 1200 includes one or more systems to support the personalization and validation of transmitting devices, such as contactless cards. The illustrated system 1200 includes a card system of record (SoR) 1150, a personalization system 1220, a database 1230, a validator system 1240, and a hardware security module (HSM) 1250. Although FIG. 12 illustrates single instances of the components, system 1200 may include any number of components.

Under certain exemplary applets or application versions, validation can require access to the database 1230. In these examples, new contactless cards can be added to the database 1230 at personalization time. This dependency between personalization and validation may be undesirable in some examples, such as when the personalization and validation functions are performed by different actors and/or entities. In some examples, a shared secret can be stored in the database 1230.

Under other exemplary applets or application versions, validation does not require access to database 1230 and instead only uses data from the data payload and/or another message. In these examples, personalization and validation may be decoupled and the dependency note above may be eliminated. In some examples, an existing pattern may be used in EMV. In some examples, a shared secret is not transmitted between devices and not recorded in database 1230. Accordingly, these examples have the benefit of personalization and validation operating independently.

The following paragraphs describe various examples of functionality that may be implemented in the systems and methods described herein. In order to decouple validation from the database (and the requirement of access to the database to perform validation), several changes may be made. First, a key pointer may be included in a data payload transmitted between devices (e.g., between a transmitting device and a receiving device), and the key pointer may replace the requirement of a database lookup upon receipt of the data payload. Second, a shared secret may be modified to be derived from a master key instead of being stored in and retrieved from a database. In some examples, modifying the shared secret is not a change to an applet or other software application. Third, one or more key derivation processes can be modified to avoid and/or stop the use of a PSN.

In some examples, a shared secret may be derived from a master key. This may result in several advantages, including that this may remove the need for a transmitting device-level secret (e.g., a card-level secret) to be stored in a database. This may further remove the need to convey the shared secret between devices (e.g., between the transmitting device and the receiving device). In addition, this may protect the secret in request data that is communicated between devices (e.g., contactless card request data).

In some examples, the shared secret can be derived from a third key. The third key may be a key previously used to perform an operation with respect to the transmitting device and/or the receiving device, or the third key may be a key that has not been previously used. In some examples, the shared secret may be personalized into the applet or other software application as is done, which may result in the avoidance of the need to change the applet or other software application. The shared secret may be enciphered before including the transmitting device to minimize the footprint for a potential attack.

In some examples, one or more key derivation processes may avoid or stop the use of the PSN. In these examples, the need to look up a PSN from a database in order to generate unique diversified keys (UDKs) is eliminated. This results in the avoidance of a dependency on a database and the retrieval of information from the database. Accordingly, personalization and validation of devices (e.g., card personalization and validation) can be performed independently.

In some examples, diversified keys can be derived from master keys using 16 digits from a pUID instead of being derived from 14 digits from the pUID and the PSN. In these examples, entropy is not decreased and further, this change can beneficially impact personalization, applet or other software, and validation. For example, an encryption master key may be used with 16 digits from the pUID to derive an encryption UDK. As another example, an authentication master key may be used with 16 digits from the pUID to derive an authentication UDK.

In some examples, a challenge may be incorporated in order to avoid or reduce the risk of preplay and/or replay attacks. Contactless cards may transmit data communications by, e.g., NFC, and such communications can be intercepted by other readers, e.g., NFC readers, and played at a later time to circumvent security requirements. This may be counteracted by binding a transmission by the contactless card, e.g., a cryptogram, to a session time (e.g., a time and/or a device).

For example, a server (or other network-enabled computer), may generate a challenge and this challenge may be linked to a session. The challenge can be written to a contactless card (e.g., to an applet contained in the memory of the contactless card) when the contactless card is within a communication field. The contactless card may use the challenge in the generation and/or calculation of a cryptogram. In addition, session validation may be added to the validation logic as part of the validation described herein.

In some examples, writing a challenge may provide many advantages, including the benefits of greatly improving security and reducing false positive declines based on application transaction counter (ATC) issues.

In some examples, writing a challenge may be implemented by changing the configuration of the contactless card. For example, the contactless card (e.g., an applet contained in the memory of the contactless card) may be provided with new internal records, including a new configuration file. The contactless card may be configured to support an optional WRITE BINARY to facilitate the transmission of the challenge to the card. The contactless card may be configured to support processes including a challenge and processes not including a challenge. In addition, the cryptogram approach utilized by the contactless card may be configured to support processes including a challenge and processes not including a challenge.

In some examples, writing a challenge may be implemented by changing the configuration of one or more software development kits (SDKs) used by the systems and methods described herein, including by the contactless card, the client device, the server, and other network-enabled computers. For example, an SDK may be updated to implement an NDEF read at the application protocol data unit (APDU) level. The SDK may be updated to determine process flows by interrogating an applet capabilities file. In addition, the SDK may be updated to request a challenge from the validator.

In some examples, writing a challenge may be implemented by changing the configuration of the validator. For example, the validator may be updated to support the generation and provision of a challenge. The validator may be updated to support the generation and provision of a session. In addition, the validatory may be updated to support validation policies based on a version number including, without limitation, an applet and/or software version number.

In some examples, additional improvements to data security, authentication, and validation can be made. For example, the use of a bespoke NFC specification can promote performance and simplify the NFC protocol. The use of a dormant applet may enable volume deployment prior to a commercial agreement with issuing entities (e.g., contactless card-issuing entities). The use of a signed hash of the card product customer identifier can simplify policy decision, which may enable confirmation that an instance owned by the appropriate customer without a mapping file relating identifiers (e.g., unique identification numbers) to customer numbers. The use of a centralized validator, such as keys in a hub, may enable light touch deployment models for issuing entities (e.g., for a pilot). In addition, the use of generic cryptography (e.g., root of trust) may enable deployment on general purpose cloud hardware security modules (HSMs).

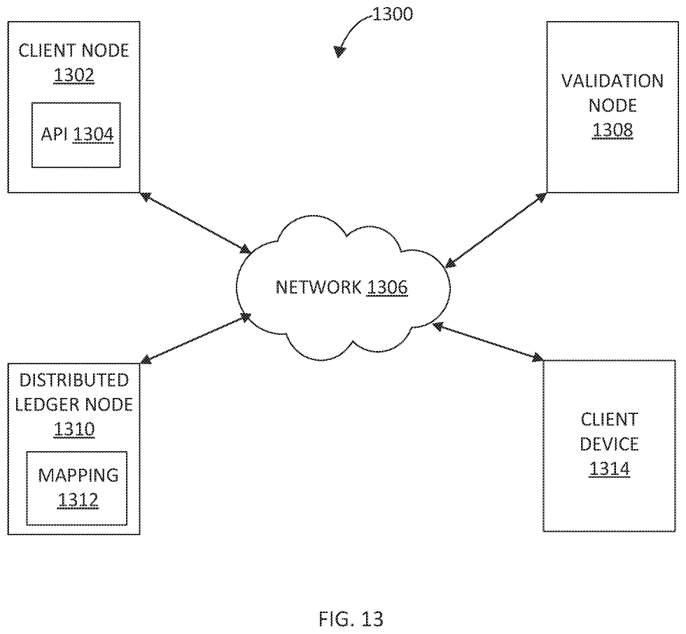

FIG. 13 illustrates a distributed network authentication system 1300 according to an example embodiment. As further discussed below, system 1300 can include client node 1302, API 1304, network 1306, distributed ledger node 1310, mapping 1312, and client device 1314. Although FIG. 13 illustrates single instances of the components, system 1300 can include any number of components.

System 1300 can include a client node 1302, which can be a network-enabled computer as described herein. In some examples, client node 1302 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, client node 1302 can execute one or more applications, such as software applications, that enable, for example, network communications with one or more components of system 1300, transmit and/or receive data, and perform the functions and processes described herein.

The client node can contain an API 1304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1304 to interact with the service, such as by performing a remote call to an API for interacting with a web-based service.

API 1304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1302 can communicate with one or more other components of system 1300 either directly or via network 1306. Network 1306 can comprise one or more of a wireless network, a wired network or any combination of wireless network and wired network, and may be configured to connect the components of system 1300. While FIG. 13 illustrates communication between the components of system 1300 through network 1306, it is understood that any component of system 1300 can communicate directly with another component of system 1300, e.g., without involving network 1306.

System 1300 can include a validation node 1308, which can be a network-enabled computer as described herein. In some examples, validation node 1308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, validation node 1308 can execute one or more applications, such as software applications, that enable, for example, network communications with one or more components of system 1300, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1300 can include a distributed ledger node 1310, which can be a network-enabled computer as described herein. In some examples, distributed ledger node 1310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, distributed ledger node 1310 can execute one or more applications, such as software applications, that enable, for example, network communications with one or more components of system 1300, transmit and/or receive data, and perform the functions and processes described herein.

Distributed ledger node 1310 can containing a mapping 1312. In some examples, mapping 1312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1300, or the one or more databases can be hosted externally to any component of the system 1300. In some examples, the one or more databases can be contained in the distributed ledger node 1310, and in other examples the one or more databases can be stored outside of distributed edger node 1310 but in data communication with distributed ledger node 1310. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1310. In other examples, the one or more databases can be remote from distributed ledger node 1310 but in data communication with distributed ledger node 1310. Data communication between the one or more databases and distributed ledger node 1310 can be a direct data communication or data communication via a network, such as the network 1306.

In some examples, client node 1302 can be in data communication with distributed ledger node 1310. Distributed ledger node 1310 can contain mapping 1312. Mapping 1314 may include, e.g., a mapping between a validation node address and the validation node 1308, a mapping between a routing number and a validation node address, and/or a mapping between a routing number and validation node 1308. In some examples, mapping 1312 can include a digital signature associated with an entity having permission to validate for a routing number. Based on one or more of these associations, client node 1302 can call validation node for validation and/or provide direction to the client device to reach the appropriate validation node. This can be accomplished by calling a validation API associated with validation node 1308.

In some examples, iterations of the mappings described herein, such as mapping 1312, can also include a software or applet version number. The version number can be used to identify a validation node or validation node address or choose between multiple validation addresses for one validation node.

In some examples, client node 1302 and distributed ledger node 1310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1310 can update mapping 1312 to reflect a different association between, e.g., a routing number, a validation node address, and a validation node. In some examples, degrees of permissions can be issued. For example, if client node 1302 were to function to route data to validation node 1308 (or other validation nodes), client node 1302 can be given a certain level of permissions. As another example, if distributed ledger node 1310 were to have the capability to update mapping 1312, distributed ledger node 1310 can have a different, higher level of permissions.

System 1300 can include a client device 1314, which can be a network-enabled computer as described herein. In some examples, distributed ledger node 1314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300. Client device 1314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1314 can be in data communication with another network-enabled computer not shown in FIG. 13, such as a smart card (e.g., a contactless card or a contact-based card).

In some examples, client device 1314 can execute one or more applications, such as software applications, that enable, for example, network communications with one or more components of system 1300, transmit and/or receive data, and perform the functions and processes described herein.

In some examples, upon receipt of an authentication request, client device 1314 can call (e.g., via an API) client node 1302. The call can include a routing number and/or an applet or software version number, and client node 1302 can query distributed ledger node 1310 and mapping 1312. Once the query returns the identification of a validation node (e.g., validation node 1308) and/or a validation node address associated with that routing number and/or applet or software version, client node 1302 can reply to client device 1314. Client device 1314 can then proceed with authentication with the validation node. The authentication can be performed by, e.g., the systems and methods described herein, such as by the generation, encryption, transmission, decryption, and validation of a cryptogram as described herein.

In some examples, client node 1302 can be co-resident with validation node 1308. In these examples, client node 1302 can handle the authentication in a single call from client device 1314. In some examples, this can be acceptable only if it is permissible for the full authentication transmission (e.g., a cryptogram as described herein) to be sent to client nodes that are not involved in authentication.

In some examples, if client node 1302 receives, from client device 1314, a routing number that is not handled by its location, client node 1302 can return a code indicating that this routing number is not handled, along with validation node address for the responsible validation node. Client device 1314 can then send the full authentication transmission to validation node 1308 using the received validation node address.

In some examples, client node 1302 can enter the distributed network with different permissions. For example, client node 1302 can be a read-only router of data. As another example, client node 1302 can have permission to send messages to distributed ledger node 1310 updating one or more routing paths for one or more routing numbers. However, client node 1302 would be prevented from updating one or more routing paths for one or more routing numbers for other entities that control other routing numbers which are not associated with client node 1302 or that did not grant this permission. As another example, distributed ledger node 1310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1302, distributed ledger node 1310, and/or validation node 1308, if security, legal, and/or financial conditions are met, however, delegation is not required.

In some examples, one or more APIs can facilitate communication between components of system 1300 via network 1306. In other examples, one or more APIs are not required. Rather, the components of system 1300 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1308 for authentication, can require storage of the keys in one or more HSMs, to promote key security and ensure that the keys are never entered into memory.

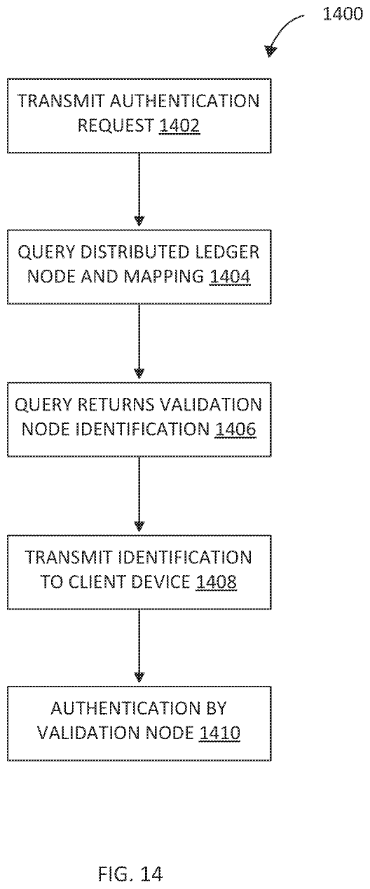

FIG. 14 illustrates a method 1400 performed by a distributed network authentication system according to an example embodiment. For example, the method can be performed by distributed network authentication system 1300 and or by another distributed network authentication system.

In block 1402, a client device can transmit an authentication request to a client node. The authentication request can include, without limitation, a routing number, a software version number, and/or an applet version number. The request can be made by an API call or other communication between the client device and the client node.

In block 1404, after receiving the authentication request, the client node can transmit a query (e.g., via an API call) to a distributed ledger node. The distributed ledger node contain a mapping, and the distributed ledger node can submit the query to the mapping.

In block 1406, the query can return an identification of a validation node and/or a validation node address, and the distributed ledger node can transmit this identification to the client node.

In block 1408, the client node can transmit the identification to the client device. After receiving the identification, the client device can proceed with authentication with the identified validation node and/or validation node address, in block 1410.

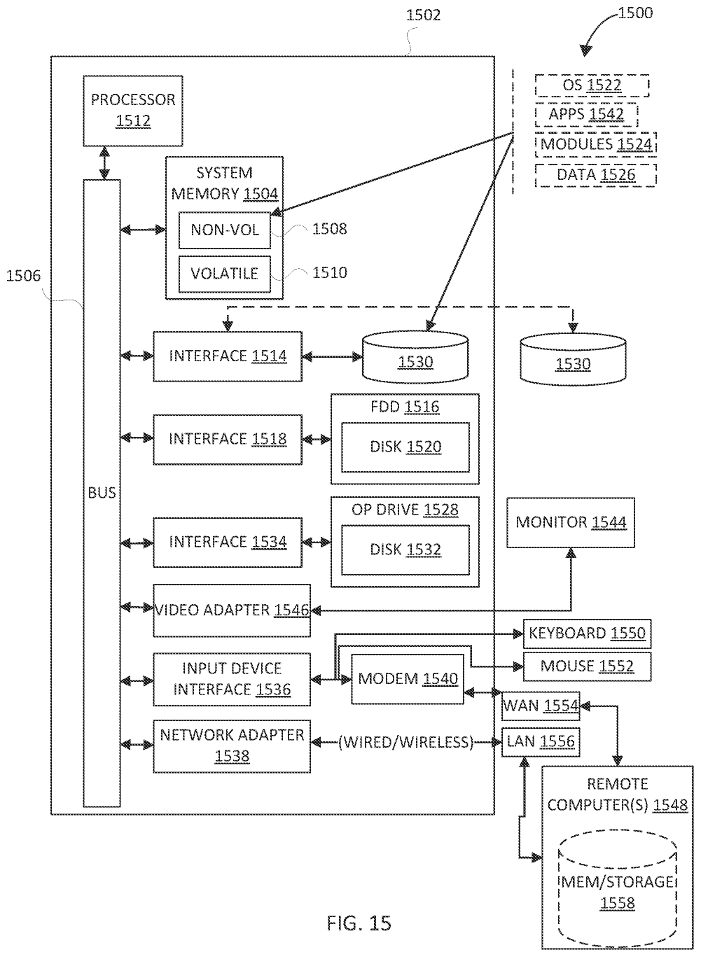

FIG. 15 illustrates an embodiment of an exemplary computer architecture 1500 suitable for implementing various embodiments as previously described. In one embodiment, the computer architecture 1500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 includes a processor 1512, a system memory 1504 and a system bus 1506. The processor 1512 can be any of various commercially available processors.

The system bus 1506 provides an interface for system components including, but not limited to, the system memory 1504 to the processor 1512. The system bus 1506 can be any of several types of bus structure that may further interconnect to a memory bus (with or without a memory controller), a peripheral bus, and a local bus using any of a variety of commercially available bus architectures. Interface adapters may connect to the system bus 1508 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

The computer 1502 may include various types of computer-readable storage media in the form of one or more lower speed memory units, including an internal (or external) hard disk drive 1530, a magnetic disk drive 1516 to read from or write to a removable magnetic disk 1520, and an optical disk drive 1528 to read from or write to a removable optical disk 1532 (e.g., a CD-ROM or DVD). The hard disk drive 1530, magnetic disk drive 1516 and optical disk drive 1528 can be connected to system bus 1506 the by an HDD interface 1514, and FDD interface 1518 and an optical disk drive interface 1534, respectively. The HDD interface 1514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1508, and volatile 1510, including an operating system 1522, one or more applications 1542, other program modules 1524, and program data 1526. In one embodiment, the one or more applications 1542, other program modules 1524, and program data 1526 can include, for example, the various applications and/or components of the systems discussed herein.

A user can enter commands and information into the computer 1502 through one or more wire/wireless input devices, for example, a keyboard 1550 and a pointing device, such as a mouse 1552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1512 through an input device interface 1536 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1502, although, for purposes of brevity, only a memory and/or storage device 1558 is illustrated. The logical connections depicted include wire/wireless connectivity to a local area network 1556 and/or larger networks, for example, a wide area network 1554. Such LAN and WAN networking environments are commonplace in offices and companies, and facilitate enterprise-wide computer networks, such as intranets, all of which may connect to a global communications network, for example, the Internet.

When used in a local area network 1556 networking environment, the computer 1502 is connected to the local area network 1556 through a wire and/or wireless communication network interface or network adapter 1538. The network adapter 1538 can facilitate wire and/or wireless communications to the local area network 1556, which may also include a wireless access point disposed thereon for communicating with the wireless functionality of the network adapter 1538.

When used in a wide area network 1554 networking environment, the computer 1502 can include a modem 1540, or is connected to a communications server on the wide area network 1554 or has other means for establishing communications over the wide area network 1554, such as by way of the Internet. The modem 1540, which can be internal or external and a wire and/or wireless device, connects to the system bus 1506 via the input device interface 1536. In a networked environment, program modules depicted relative to the computer 1502, or portions thereof, can be stored in the remote memory and/or storage device 1558. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

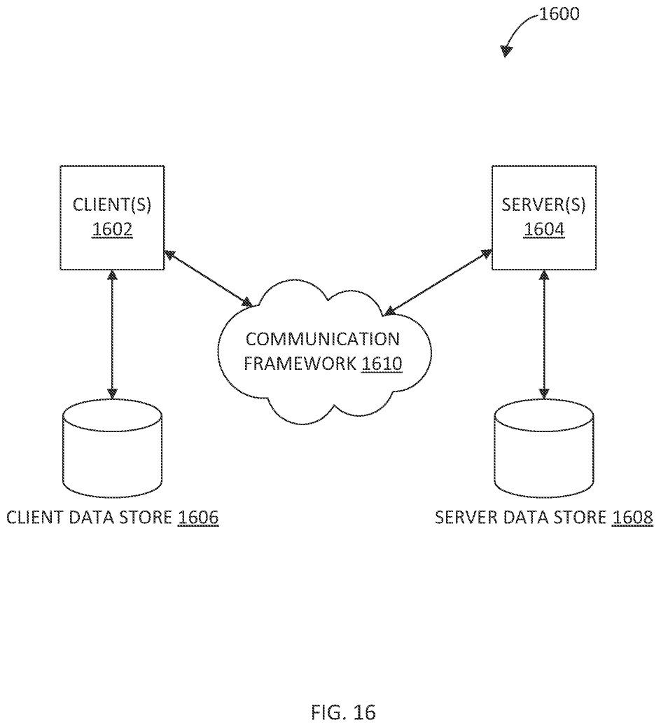

FIG. 16 is a block diagram depicting an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600, which may be consistent with systems and devices discussed herein.

As shown in FIG. 16, the communications architecture 1600 includes one or more client(s) 1602 and server(s) 1604. The server(s) 1604 may implement one or more functions and embodiments discussed herein. The client(s) 1602 and the server(s) 1604 are operatively connected to one or more respective client data store 1606 and server data store 1608 that can be employed to store information local to the respective client(s) 1602 and server(s) 1604, such as cookies and/or associated contextual information.

The client(s) 1602 and the server(s) 1604 may communicate information between each other using a communication framework 1610. The communication framework 1610 may implement any well-known communications techniques and protocols. The communication framework 1610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1602 and the server(s) 1604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

It is noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In some aspects, the techniques described herein relate to a distributed network authentication system, including: a client node; and a distributed ledger node in data communication with the client node, wherein the distributed ledger contains a database storing a mapping; and wherein the client node is configured to: receive, from a client device, an authentication request, and responsive to the authentication request, transmit, to the distributed ledger node, a query, and wherein the distributed ledger node is configured to: receive, from the client node, the query, submit the query to the database, receive, from the database responsive to the query, an identification of at least one selected from the group of a validation node and a validation node address, and transmit, to the client node, the identification.

In some aspects, the techniques described herein relate to a distributed network authentication system, wherein the client node is further configured to transmit the identification to the client device.

In some aspects, the techniques described herein relate to a distributed network authentication system, further including: the validation node, wherein the validation node is configured to: communicate to communicate with the client device, and perform an authentication relating to the authentication request.

In some aspects, the techniques described herein relate to a distributed network authentication system, wherein the validation node is associated with the validation node address.

In some aspects, the techniques described herein relate to a distributed network authentication system, wherein the authentication includes at least one selected from the group of a routing number, a software version number, and an applet version number.

In some aspects, the techniques described herein relate to a distributed network authentication system, wherein the authentication request includes an application programming interface (API) call between the client device and the client node.

In some aspects, the techniques described herein relate to a distributed network authentication system, wherein the mapping includes at least one selected from the group of a mapping between the validation node address and the validation node, a mapping between a routing number and the validation node address, and a mapping between a routing number and the validation node.

In some aspects, the techniques described herein relate to a distributed network authentication system, wherein: the mapping includes a digital signature associated with an entity, and the entity is permissioned to validate for a particular routing number.

In some aspects, the techniques described herein relate to a distributed network authentication system, wherein the mapping includes at least one selected from the group of a software version number and an applet version number.

In some aspects, the techniques described herein relate to a distributed network authentication system, wherein the at least one selected from the group of a software version number and an applet version number identifies the validation node.

In some aspects, the techniques described herein relate to a distributed network authentication system, wherein the at least one selected from the group of a software version number and an applet version number identifies the validation node address.

In some aspects, the techniques described herein relate to a method performed by a distributed network authentication system including a client node and a distributed ledger node, the method including: receiving, by the client node from a client device, an authentication request; responsive to the authentication request, transmitting, by the client node to the distributed ledger node, a query, receiving, by the distributed ledger node from the client node, the query, submitting, by the distributed ledger node, the query to the database, receiving, by the distributed ledger node from the database responsive to the query, an identification of at least one selected from the group of a validation node and a validation node address, and transmitting, by the distributed ledger node to the client node, the identification.

In some aspects, the techniques described herein relate to a method, wherein: the distributed network authentication system further includes the validation node, and the method further includes: communicating, by the client device, with the validation node, and performing, by the validation node, an authentication relating to the authentication request.

In some aspects, the techniques described herein relate to a method, wherein: the validation node includes a hardware security module storing one or more keys, and the authentication is performed using the one or more keys.

In some aspects, the techniques described herein relate to a method, further including transmitting, by the client node to the distributed ledger node, a message updating one or more routing paths for one or more routing numbers.

In some aspects, the techniques described herein relate to a method, wherein the client node is assigned one or more permissions allowing the update of the one or more routing paths for the one or more routing numbers.

In some aspects, the techniques described herein relate to a method, wherein: the one or more permissions are assigned for one or more entities associated with the client node, and the one or more entities are associated with the one or more routing paths for the one or more routing numbers.

In some aspects, the techniques described herein relate to a method, further including, prior to updating the one or more routing paths for one or more routing numbers, validating, by the distributed ledger node, the one or more permissions.

In some aspects, the techniques described herein relate to a non-transitory computer-readable medium including instructions for execution by a distributed network authentication system including a distributed ledger node containing a database, wherein, when executed, the instructions cause the distributed network authentication system to perform procedures including: receiving, from a client node, a query, submitting the query to the database, receive, from the database responsive to the query, an identification of at least one selected from the group of a validation node and a validation node address, and transmit, to the client node, the identification.

In some aspects, the techniques described herein relate to a non-transitory computer-readable medium, wherein: the distributed network authentication system further includes the client node, and the procedures further include: receiving, by the client node from a client device, an authentication request, and responsive to the authentication request, transmitting, by the client node to the distributed ledger node, the query.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Steps described herein need not be performed in the same sequence discussed or with the same degree of separation. Likewise various steps may be omitted, repeated, or combined, as necessary, to achieve the same or similar objectives. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A distributed network authentication system, comprising:
a client node; and
a distributed ledger node in data communication with the client node, wherein the distributed ledger contains a database storing a mapping; and
wherein the client node is configured to:
receive, from a client device, an authentication request, and
responsive to the authentication request, transmit, to the distributed ledger node, a query, and
wherein the distributed ledger node is configured to:
receive, from the client node, the query,
submit the query to the database,
receive, from the database responsive to the query, an identification of at least one selected from the group of a validation node and a validation node address, and
transmit, to the client node, the identification.

2. The distributed network authentication system of claim 1, wherein the client node is further configured to transmit the identification to the client device.

3. The distributed network authentication system of claim 1, further comprising:
the validation node,
wherein the validation node is configured to:
communicate to communicate with the client device, and
perform an authentication relating to the authentication request.

4. The distributed network authentication system of claim 3, wherein the validation node is associated with the validation node address.

5. The distributed network authentication system of claim 1, wherein the authentication includes at least one selected from the group of a routing number, a software version number, and an applet version number.

6. The distributed network authentication system of claim 1, wherein the authentication request comprises an application programming interface (API) call between the client device and the client node.

7. The distributed network authentication system of claim 1, wherein the mapping includes at least one selected from the group of a mapping between the validation node address and the validation node, a mapping between a routing number and the validation node address, and a mapping between a routing number and the validation node.

8. The distributed network authentication system of claim 1, wherein:
the mapping includes a digital signature associated with an entity, and
the entity is permissioned to validate for a particular routing number.

9. The distributed network authentication system of claim 1, wherein the mapping includes at least one selected from the group of a software version number and an applet version number.

10. The distributed network authentication system of claim 9, wherein the at least one selected from the group of a software version number and an applet version number identifies the validation node.

11. The distributed network authentication system of claim 9, wherein the at least one selected from the group of a software version number and an applet version number identifies the validation node address.

12. A method performed by a distributed network authentication system comprising a client node and a distributed ledger node, the method comprising:
receiving, by the client node from a client device, an authentication request;
responsive to the authentication request, transmitting, by the client node to the distributed ledger node, a query,
receiving, by the distributed ledger node from the client node, the query,
submitting, by the distributed ledger node, the query to the database,
receiving, by the distributed ledger node from the database responsive to the query, an identification of at least one selected from the group of a validation node and a validation node address, and
transmitting, by the distributed ledger node to the client node, the identification.

13. The method of claim 12, wherein:
the distributed network authentication system further comprises the validation node, and
the method further comprises:
communicating, by the client device, with the validation node, and
performing, by the validation node, an authentication relating to the authentication request.

14. The method of claim 13, wherein:
the validation node comprises a hardware security module storing one or more keys, and
the authentication is performed using the one or more keys.

15. The method of claim 12, further comprising transmitting, by the client node to the distributed ledger node, a message updating one or more routing paths for one or more routing numbers.

16. The method of claim 15, wherein the client node is assigned one or more permissions allowing the update of the one or more routing paths for the one or more routing numbers.

17. The method of claim 16, wherein:
the one or more permissions are assigned for one or more entities associated with the client node, and
the one or more entities are associated with the one or more routing paths for the one or more routing numbers.

18. The method of claim 17, further comprising, prior to updating the one or more routing paths for one or more routing numbers, validating, by the distributed ledger node, the one or more permissions.

19. A non-transitory computer-readable medium comprising instructions for execution by a distributed network authentication system comprising a distributed ledger node containing a database, wherein, when executed, the instructions cause the distributed network authentication system to perform procedures comprising:
receiving, from a client node, a query,
submitting the query to the database,
receive, from the database responsive to the query, an identification of at least one selected from the group of a validation node and a validation node address, and
transmit, to the client node, the identification.

20. A non-transitory computer-readable medium, wherein:
the distributed network authentication system further comprises the client node, and
the procedures further comprise:
receiving, by the client node from a client device, an authentication request, and
responsive to the authentication request, transmitting, by the client node to the distributed ledger node, the query.
